(19) United States
(12) Patent Application Publication
(10) Pub. No.: US 2026/0277436 A1
(43) Pub. Date: Sep. 17, 2026

(54) MEMORY SYSTEM, MEMORY CONTROLLER, AND CONTROL METHOD OF DATA ARRANGEMENT

(71) Applicant: Kioxia Corporation, Tokyo (JP)

(72) Inventors: Tomoya KONISHI, Kawasaki Kanagawa (JP); Tomoyuki KANTANI, Yokohama Kanagawa (JP)

(73) Assignee: Kioxia Corporation, Tokyo (JP)

(21) Appl. No.: 19/314,274

(22) Filed: Aug. 29, 2025

(30) Foreign Application Priority Data
Mar. 11, 2025 (JP) 2025-038388

(51) Int. Cl. G06F 3/06

(52) U.S. Cl. CPC G06F 3/0608; G06F 3/0659; G06F 3/0679

(57) ABSTRACT

The memory system includes a nonvolatile memory and a memory controller. The memory controller executes first writing and second writing, and has a first queue. In writing data, the memory controller writes the data into nonvolatile memory with the first writing and stores, in the first queue, block numbers of blocks on which the first writing is executed in an order of execution. When generating an empty capacity in the nonvolatile memory by rewriting the data having undergone the first writing with the second writing, the memory controller acquires the block numbers from the first queue in the order they were stored, and selects, as movement source blocks of the garbage collection process, the blocks corresponding to the acquired block numbers.

### CROSS-REFERENCE TO RELATED APPLICATION

This application is based upon and claims the benefit of priority from Japanese Patent Application No. 2025-038388, filed Mar. 11, 2025, the entire contents of which are incorporated herein by reference.

### FIELD

Embodiments described herein relate generally to a memory system, a memory controller, and a control method of data arrangement.

### BACKGROUND

Memory systems having a NAND flash memory as a storage medium, such as an SSD (solid state drive), have widely spread in recent years. Components of such a memory system including a NAND flash memory are integratedly controlled by a memory controller.

Among the memory systems, there exists a memory system that supports QLC (quad level cell) writing to write 4-bit data into each cell of the NAND flash memory. The memory controller in this type of memory system also uses, in addition to the QLC writing, SLC (single level cell) writing to write 1-bit data into each cell, and TLC (triple level cell) writing to write 3-bit data into each cell. Selection among these types of writing can be made for each of a plurality of blocks included in the NAND flash memory. Blocks undergoing the SLC writing of data are called SLC blocks, and blocks undergoing the QLC writing of data are called QLC blocks.

For example, each SLC block has a small storage capacity of data per cell but has a high write speed, and meanwhile, each QLC block has a large storage capacity of data per cell but has a low write speed. In consideration of such characteristics of the blocks, the memory controller once writes data for which a write request is made by a host into the SLC blocks, and after that, moves the data in the SLC blocks to a QLC block. To move data in SLC blocks to a QLC block is called garbage collection (GC) since it increases the empty capacity in the NAND flash memory.

By virtue of this control by the memory controller, the memory system achieves both maintenance of writing performance and securing of the storage capacity for data. When moving data from SLC blocks to QLC blocks, it is preferable for the memory controller to control arrangement of data such that the data are arranged, for example, in the order of the writing. Nonetheless, it has been difficult to arrange the data in the order of the writing still in the QLC blocks that are movement destinations for GC.

### BRIEF DESCRIPTION OF THE DRAWINGS

FIG. 1 is a diagram showing a configurational example of a memory system of a first embodiment.

FIG. 2 is a first diagram for explaining a comparative example to the memory system of the first embodiment.

FIG. 3 is a second diagram for explaining the comparative example to the memory system of the first embodiment.

FIG. 4 is a first diagram for explaining GC in the memory system of the first embodiment.

FIG. 5 is a second diagram for explaining the GC in the memory system of the first embodiment.

FIG. 6 is a flowchart showing a procedure of the GC in the memory system of the first embodiment.

FIG. 7 is a first diagram for explaining GC in a memory system of a second embodiment.

FIG. 8 is a second diagram for explaining the GC in the memory system of the second embodiment.

FIG. 9 is a flowchart showing a procedure of the GC in the memory system of the second embodiment.

### DETAILED DESCRIPTION

An embodiment of the present disclosure provides a memory system, a memory controller, and a control method of data arrangement that can appropriately control arrangement of data.

In general, according to one embodiment, a memory system includes a nonvolatile memory and a memory controller. The nonvolatile memory has a plurality of blocks each including a plurality of cells. The memory controller is connectable to a host and controls the nonvolatile memory. The memory controller is able to execute, for each of the plurality of blocks, first writing to write N-bit data (N is an integer not less than 1) into one cell and second writing to write M-bit data (M is an integer greater than N) into one cell. The memory controller has a first queue for storing block numbers respectively assigned to the plurality of blocks. When writing of data into the nonvolatile memory is requested by the host, the memory controller writes the data into the nonvolatile memory with the first writing and stores, in the first queue, block numbers of blocks on which the first writing is executed such that an order in which the first writing has been executed is able to be specified. When garbage collection processing of generating an empty capacity in the nonvolatile memory by rewriting and moving the data written in the nonvolatile memory with the first writing into the nonvolatile memory with the second writing is executed, the memory controller acquires the block numbers of the blocks on which the first writing is executed, in the order in which the first writing has been executed, the block numbers being stored in the first queue, and in an order in which the block numbers are acquired, selects, as movement source blocks of the garbage collection processing, the blocks to which the block numbers are assigned and on which the first writing is executed.

Hereafter, embodiments are described with reference to the drawings.

### First Embodiment

First, a first embodiment is described.

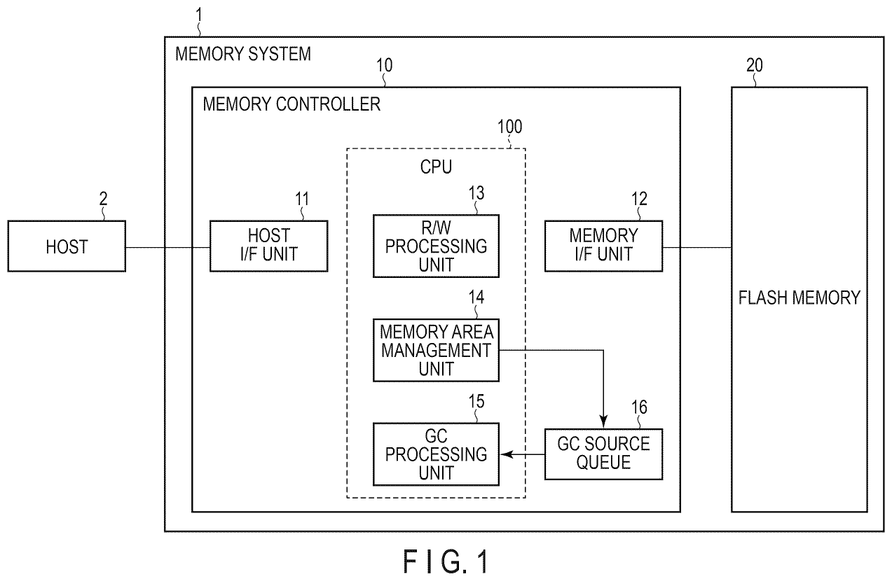

FIG. 1 is a diagram showing a configurational example of a memory system 1 of the first embodiment. FIG. 1 shows the memory system 1 in the state of being connected to a host 2 to constitute an information processing system together with the host 2. The host 2 is an information processing apparatus such as a personal computer or a server.

The memory system 1 is, for example, an SSD, and has a memory controller 10 and a flash memory 20. The memory controller 10 is also referred to simply as a controller.

The memory controller 10 is an apparatus that controls the flash memory 20. Specifically, the memory controller 10 controls write processing of data into the flash memory 20 or controls read processing of data from the flash memory 20 in response to a command from the host 2.

In order to perform management of the flash memory 20 including the GC, the memory controller 10 occasionally controls write processing of data into the flash memory 20 and/or read processing of data from the flash memory 20 autonomously regardless of a command from the host 2. The memory controller 10 is implemented as a SoC (System on a Chip) or the like.

The flash memory 20 is a nonvolatile memory having a plurality of blocks each including a plurality of memory cells. In the memory system 1 of the first embodiment, the memory controller 10 can execute SLC writing to write 1-bit data into one cell on the flash memory 20, and moreover, can execute QLC writing to write 4-bit data into one cell thereon. Selection among these types of writing can be made for each of the plurality of blocks included in the flash memory 20. Blocks to undergo the SLC writing are called SLC blocks, and blocks to undergo the QLC writing are called QLC blocks. Each SLC block has a small storage capacity of data per cell but has a high write speed, and meanwhile, each QLC block has a large storage capacity of data per cell but has a low write speed.

The memory controller 10 has a host interface unit (host I/F unit) 11, a memory interface unit (memory I/F unit) 12, a read and write processing unit (R/W processing unit) 13, a memory area management unit 14, a GC processing unit 15, and a GC source queue 16. There is herein presented an example in which, among constituents of the memory controller 10, the host I/F unit 11 and the memory I/F unit 12 are implemented in hardware such as electric circuits, and the R/W processing unit 13, the memory area management unit 14, and the GC processing unit 15 are implemented by a CPU (Central Processing Unit) 100 executing programs called firmware or the like, the CPU 100 being built in the memory controller 10. Notably, the R/W processing unit 13, the memory area management unit 14, and the GC processing unit 15 may be implemented in hardware such as electric circuits as with the host I/F unit 11 and the memory I/F unit 12.

For example, the host I/F unit 11 connects to the host 2 with an interface compliant with the PCI Express™ (PCIe™) standard, and performs control for communicating with the host 2 according to a protocol compliant with the NVM Express™ (NVMe™) standard. For example, the host I/F unit 11 may be compliant with the UFS (Universal Flash Storage) standard.

The memory I/F unit 12 controls writing of data into the flash memory 20 and reading of data from the flash memory 20. For example, the memory I/F unit 12 is compliant with the toggle DDR (Double data Rate) standard or the ONFI (Open NAND Flash Interface) standard.

When a read command is received by the host I/F unit 11, the R/W processing unit 13 reads data requested to be read (read data) from the flash memory 20 via the memory I/F unit 12. Then, the R/W processing unit 13 transmits the read data which is read from the flash memory 20 by the memory I/F unit 12 to the host 2 via the host I/F unit 11.

Moreover, when a write command is received by the host I/F unit 11, the R/W processing unit 13 writes data requested to be written (write data) into the flash memory 20 via the memory I/F unit 12. Then, when the writing of the write data into the flash memory 20 is successful, the R/W processing unit 13 notifies the host 2 of the completion of the writing, via the host I/F unit 11.

Furthermore, in response to an instruction from the GC processing unit 15 mentioned later, not to a command from the host 2, the R/W processing unit 13 executes reading of data from the flash memory 20 or writing of data into the flash memory 20.

The memory area management unit 14 manages the state of the flash memory 20. The memory area management unit 14 manages, for example, a remaining capacity of the flash memory 20, states of the blocks of the flash memory 20, and the like as information indicating the state of the flash memory 20. The states of the blocks include a SLC block state, a QLC block state, and an invalid or empty block state that is ready for writing. A block is in an invalid state after its valid data has been moved to another block (including movement by overwriting) or being deleted, making it available for new data. The invalid block state can also be called an empty state.

Moreover, the memory area management unit 14 stores, in the GC source queue 16, information required for the GC processing unit 15 mentioned later to execute GC processing while appropriately controlling arrangement of data. The information stored in the GC source queue 16 includes block numbers assigned to the blocks of the flash memory 20. Details of this storing of the block numbers in the GC source queue 16 are mentioned later.

The GC processing unit 15 executes the GC processing of increasing the remaining capacity of the flash memory 20 by moving data of SLC blocks to a QLC block based on the states of the blocks of the flash memory 20 and the information stored in the GC source queue 16, the states and the information being managed by the memory area management unit 14.

For example, the GC source queue 16 is a memory area that is secured in an SRAM (static RAM [random access memory]) built in the memory system 1 to store the block numbers mentioned above.

The memory system 1 of the first embodiment having the configuration as above temporarily writes data from the host 2 into SLC blocks as primary reception, and under the control by the GC processing unit 15, moves the data from the SLC blocks to a QLC block. Thereby, the memory system 1 achieves both maintenance of writing performance and securing of the storage capacity for data.

Now, there is considered a case where the host 2 performs writing of data from the top to the vicinity of the end of a virtual address space to which an area of the flash memory 20 provided from the memory system 1 is mapped. The total capacity of the virtual address space corresponds to the total amount of data in the case of QLC writing of the data into the relevant area of the flash memory 20. Virtual addresses indicating positions in the virtual address space are also called logical addresses. Namely, it is considered to perform writing in the ascending order from logical address 0.

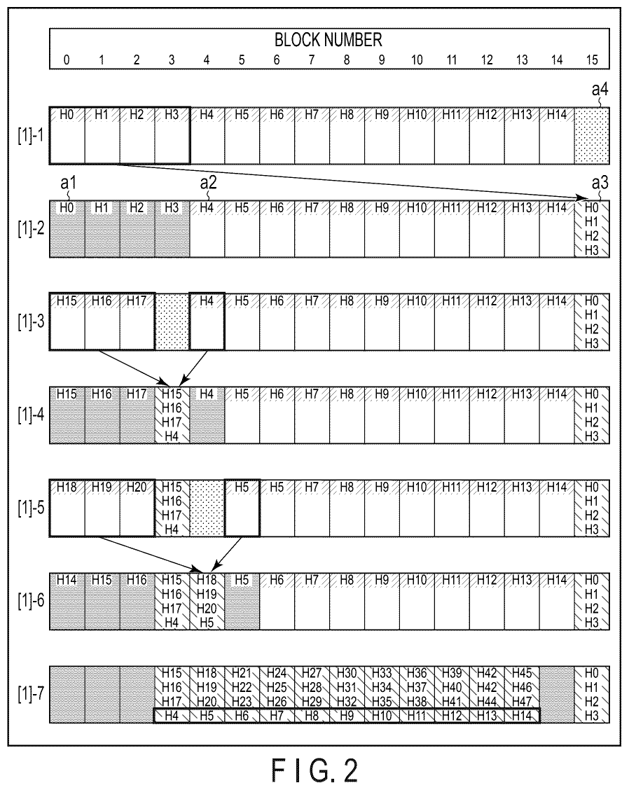

First, a comparative example to the memory system 1 of the first embodiment is described. FIG. 2 shows an example in which, for simplification, there is the maximum capacity of 16 blocks in the flash memory and the blocks for temporary reception are SLC blocks.

The memory controller executes the GC of moving data in the SLC blocks to a QLC block simultaneously while performing the temporary reception of the data from the host into the SLC blocks. Here, it is supposed that both the SLC blocks as write destinations of the data from the host and the QLC block as a write destination for the GC are included in the prepared 16 blocks, and invalid blocks that have smaller block numbers are always selected as the write destinations.

In FIG. 2, Hn (n is an integer not less than zero) denotes data written from the host in the time series order. Hatchings put on frames indicated by sign a1 indicate invalid blocks. Hatchings put on frames indicated by sign a2 indicate SLC blocks. Hatchings put on frames indicated by sign a3 indicate QLC blocks. Hatchings put on frames indicated by sign a4 indicate QLC blocks that are as GC destinations. Moreover, frames with bold lines indicate blocks that are selected as GC sources.

At the time point of [1]-1, GC occurs due to the lack of the capacity. As to the group of SLC blocks as GC sources, since writing is executed in the order of the logical addresses until all the blocks are filled, for the purpose of securing an empty capacity, any of the SLC blocks can be selected without any problems. Here, when the blocks as the GC sources are selected in the order of smaller block numbers, the data written in the 15th block as the GC write destination are arranged in the order of having been written ([1]-2).

Likewise, also in the state of [1]-3, GC occurs due to the lack of the capacity, new data from the host is written into block numbers 0 to 2 that have become empty blocks, and furthermore, block number 3 is used as a GC destination. Therefore, the new data in block numbers 0 to 2 and the old data in block number 4 are collectively written into the GC destination, which results in generating a QLC block at [1]-4 in which the data are not arranged in the order of having been written.

Further, the total capacity is used up by repeating writing as shown in [1]-5 and [1]-6, which results in a block group having QLC blocks that stores data some of which are not in time series as shown in [1]-7.

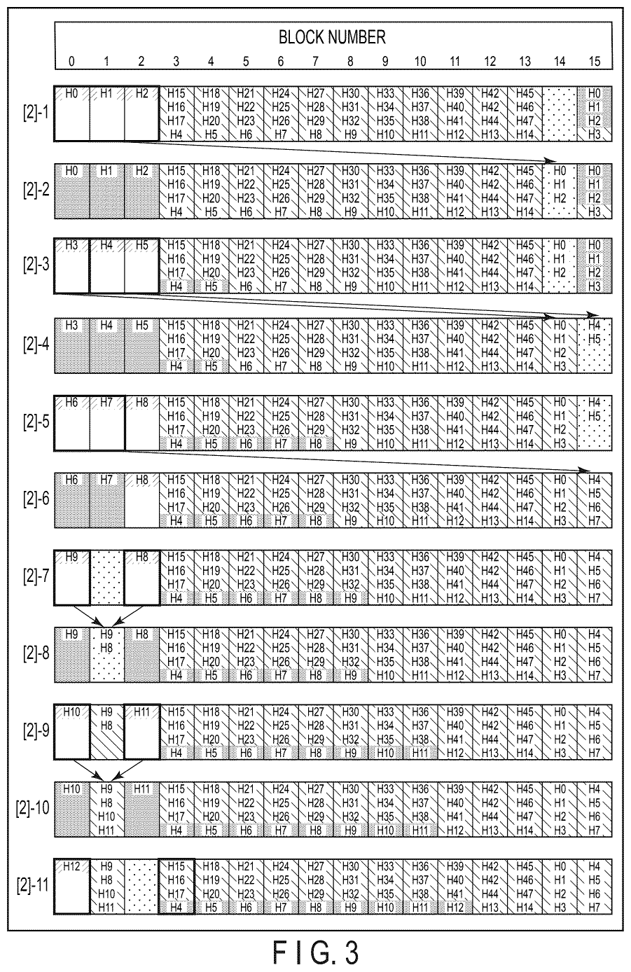

Subsequently, in this state, writing in the ascending order from logical address 0 is performed again. FIG. 3 shows an example.

GC occurs due to the lack of the capacity at the time point of [2]-1. Block 15 having the old data is invalidated by overwriting with data H0 to H3 written from the host ([2]-1 to [2]-3).

Nonetheless, as to H4 and H5 as next writing, since H4 and H5 are distributed in block numbers 3 and 4, the situation that the entirety of these blocks is not invalidated occurs([2]-3 to [2]-4).

When GC is repeated in this situation ([2]-5 to [2]-10), the capacity is used up without block invalidation by overwriting occurring, and this causes a need for selecting a QLC block as a GC source ([2]-11). For example, since the QLC block of block number 3 is a block in which a remaining capacity is below a prescribed level, e.g., ¾ of the capacity, is used, an empty capacity can be secured only after three times the data of the SLC block is moved, and moreover, the read speed from this GC source is slow. This results in occurrence of significant performance deterioration.

In consideration of the comparative example above, the description returns to the memory system 1 of the first embodiment.

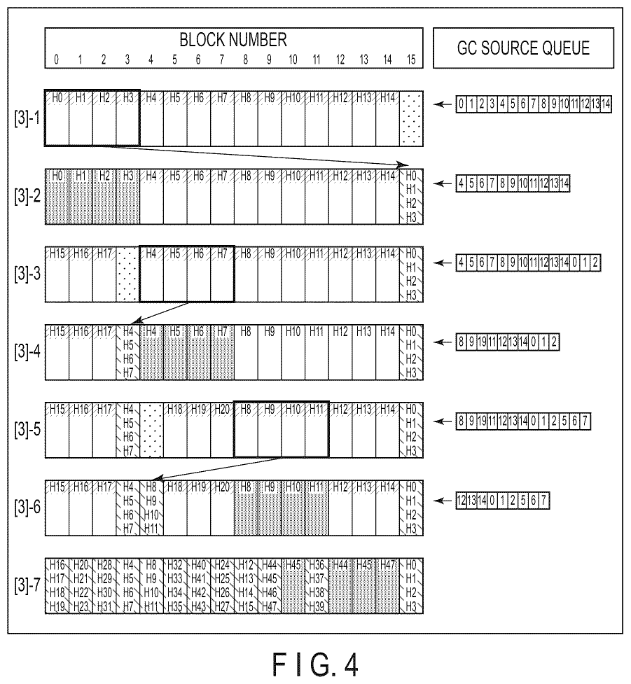

As mentioned above, the first embodiment of the memory system 1 has the GC source queue 16. The memory system 1 of the first embodiment records the time series of the GC sources by means of the GC source queue 16. FIG. 4 shows an example in which there is the maximum capacity of 16 blocks and the blocks for temporary reception are SLC blocks as with the comparative example.

The GC source queue 16 is managed in a FIFO (first in, first out) manner. The memory controller 10 (memory area management unit 14) sequentially stores block numbers on which writing from the host 2 is executed in the GC source queue.

As with the comparative example, when the host 2 executes the writing in the ascending order from logical address 0, in the memory system 1 of the first embodiment, the written block numbers are continuously stored in the GC source queue as at [3]-1.

Here, GC occurs due to the lack of the capacity, and in this stage, the memory controller 10 (GC processing unit 15) selects SLC blocks that are as the GC sources, in the order of being stored in the GC source queue 16.

Thereby, in a QLC block that is written by the GC, the data are always arranged in the order of having been written ([3]-2, [3]-3, and [3]-4). By repeating this, the state that in the final stage, all the QLC blocks have data arranged in the writing order is achieved ([3]-7).

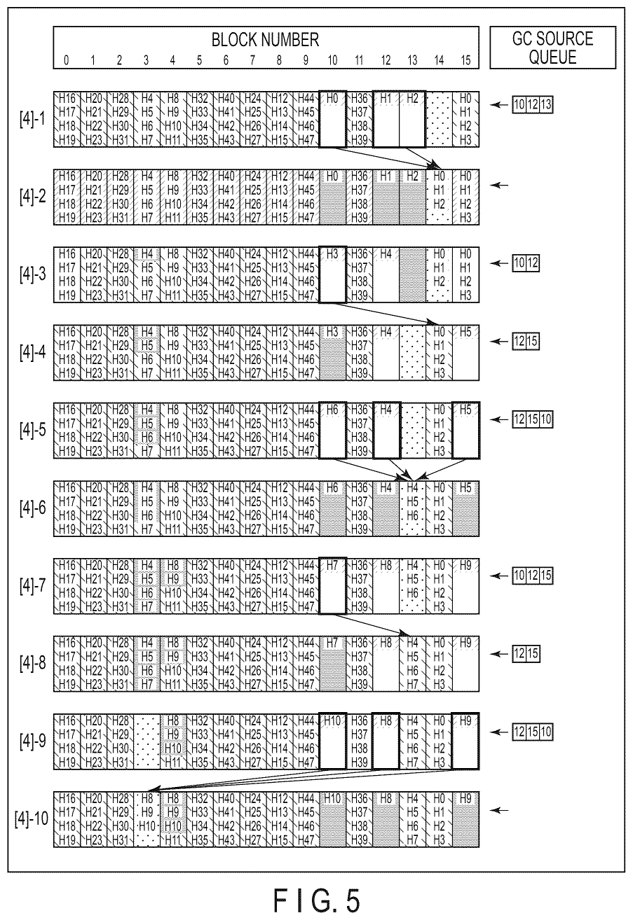

FIG. 5 shows an example in which, in this state, writing in the second cycle (to execute writing again in the ascending order from logical address 0) is started.

As with the comparative example, block 15 having the old data is invalidated by overwriting with data H0 to H3 written from the host 2 ([4]-1 to [4]-3). Also as to H4 to H7 as the next writing, since H4 to H7 are arranged in the time series order in the block of block number 3, invalid blocks are generated by the overwriting ([4]-4 to [4]-7).

This generation of the invalid blocks can prevent the capacity from running short even while the processing continues, and the memory system 1 of the first embodiment can prevent an event of selecting a QLC block as the GC source.

As above, the memory system 1 of the first embodiment records the time series of the GC sources with the GC source queue 16 provided and selects the SLC blocks that are as the GC sources in the recorded order. Thereby, the memory system 1 of the first embodiment prevents an event of selecting a QLC block as the GC source and prevents significant performance deterioration from occurring.

In other words, the memory system 1 of the first embodiment can appropriately control arrangement of data.

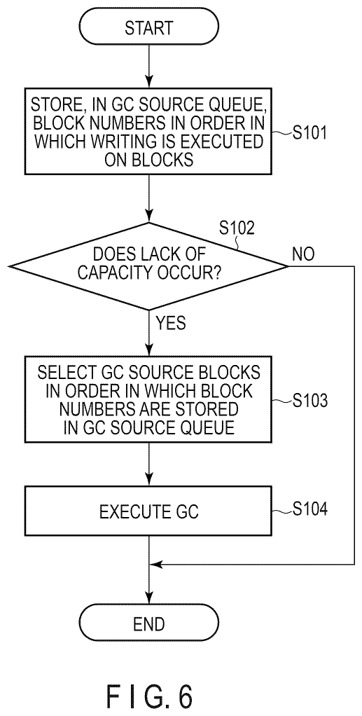

FIG. 6 is a flowchart showing a procedure of the GC in the memory system 1 of the first embodiment.

The memory controller 10 stores the block numbers in the GC source queue 16 in the order in which the writing has been executed (S101). The memory controller 10 determines whether or not the lack of the capacity in the flash memory 20 occurs (S102).

When the lack of the capacity occurs (S102: YES), the memory controller 10 selects GC source blocks in the order in which the block numbers are stored in the GC source queue 16 (S103) and executes GC (S104).

When the lack of the capacity does not occur (S102: NO), the memory controller 10 skips S103 and S104, and ends the processing regarding GC.

As above, the memory system 1 of the first embodiment can appropriately control arrangement of data and achieves both maintenance of writing performance and securing of the storage capacity for data.

### Second Embodiment

Next, a second embodiment is described.

As with the first embodiment, the second embodiment is also described with an example of a memory system that may be implemented, for example, as an SSD. The same signs are used for the same constituents as those of the first embodiment, and the description thereof is omitted.

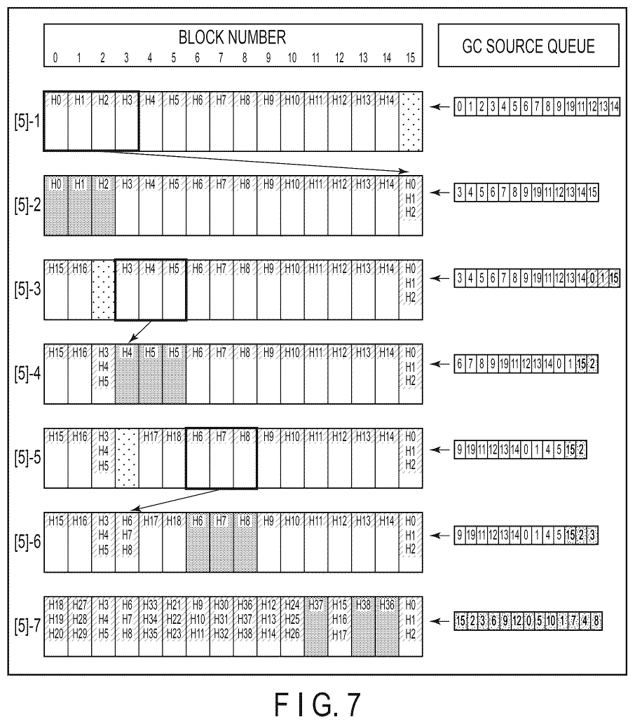

As with the first embodiment, the memory system 1 of the second embodiment receives data from the host 2 with SLC blocks. Nonetheless, the memory system 1 of the second embodiment moves the data in the SLC blocks to TLC blocks when the capacity of the written data is less than a prescribed value, and moves the data in the TLC blocks to QLC blocks when the capacity of the written data exceeds the prescribed value. FIG. 7 shows an example.

First, as with the first embodiment, the memory controller 10 stores the block numbers of the blocks on which the SLC writing of the data is executed in the GC source queue in the order of the writing ([5]-1). When the capacity of the written data increases and GC is needed, the memory controller 10 refers to the GC source queue 16 to select the SLC blocks and writes the data of the selected SLC blocks into the TLC block. In this stage, the number of the TLC block generated by the GC is also stored at the end of the GC source queue ([5]-2).

In this state, when writing into SLC blocks further occurs (block numbers 0 and 1 at [5]-3), the memory controller 10 inserts the block numbers corresponding to the newly written SLC blocks at a position in the GC source queue 16 immediately preceding the block numbers of the previously established TLC block. Therefore, the order of the SLC writing from the host 2 can be held. Notably, any storing method of the block numbers of the SLC blocks and the block numbers of the TLC blocks in the GC source queue 16 may be employed as long as the order of those can be specified.

After repeating this ([5]-5 and [5]-6), in the final stage, the group of the TLC blocks that are arranged in the time series is generated, and moreover, the block numbers are stored in the GC source queue 16 in the written order ([5]-7).

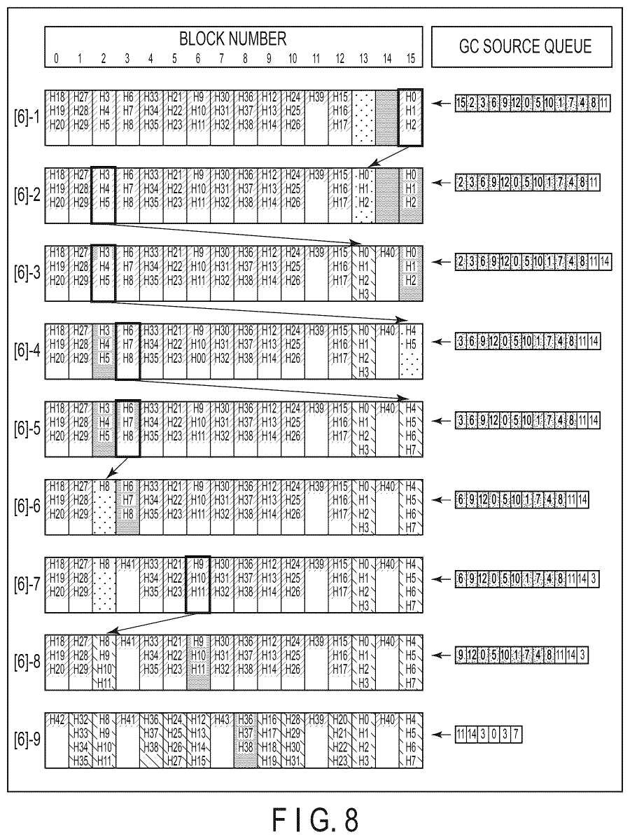

FIG. 8 shows processing in the case where writing further progresses, and a capacity cannot be secured unless the data is moved to QLC blocks.

In order to secure the capacity, the memory controller 10 refers to the GC source queue 16 to select the TLC blocks and executes GC of moving the data of the selected TLC blocks to the QLC blocks ([6]-1, [6]-2, and [6]-3). Since the TLC blocks are arranged in the time series, by executing GC in the order in which the block numbers are stored in the GC source queue 16, invalid blocks can be generated, and the data of the written QLC blocks are also arranged in the time series order ([6]-5).

By repeating this, in the final stage, the group of the QLC blocks that are arranged in the time series order is generated ([6]-9), as with the first embodiment, invalid block generation by overwriting is performed even when writing in the second cycle is executed, and an event of selecting QLC blocks as the GC sources can be prevented.

Notably, after the GC of moving the data to the QLC blocks is started, as with the first embodiment, writing from the host 2 is received by SLC blocks and the block numbers of those are stored at the end of the GC source queue 16, and they are not inserted before the TLC ([6]-1 and [6]-3). Therefore, the order of writing from the host 2 can be held still after the QLC writing is started.

As above, the memory system 1 of the second embodiment can also appropriately control arrangement of data and maintain writing performance.

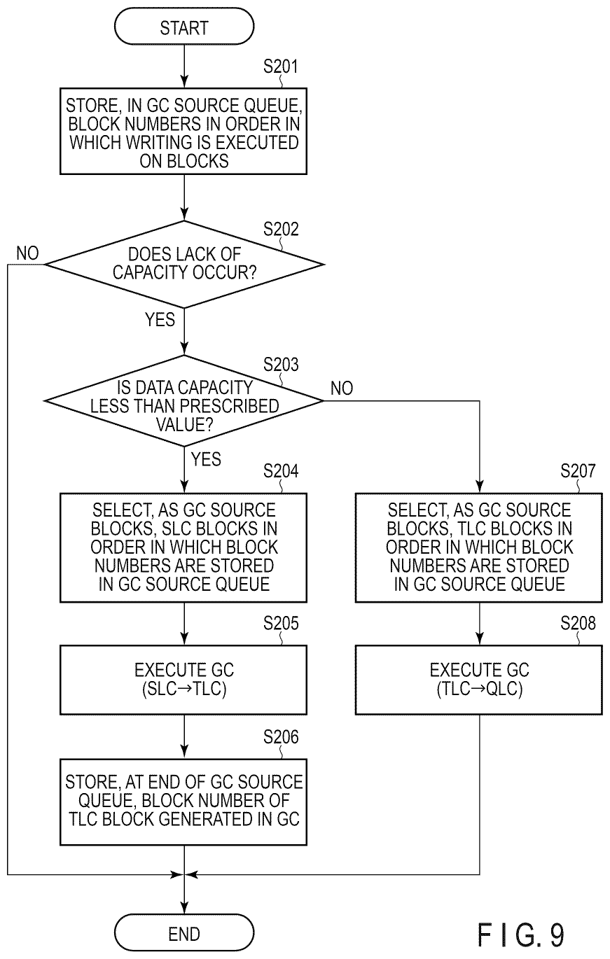

FIG. 9 is a flowchart showing a procedure of GC in the memory system 1 of the second embodiment.

The memory controller 10 stores the block numbers in the GC source queue 16 in the order in which the writing has been executed (S201). The memory controller 10 determines whether or not the lack of the capacity in the flash memory 20 occurs (S202).

When the lack of the capacity occurs (S202: YES), the memory controller 10 subsequently determines whether or not the data capacity is less than a prescribed value (S203). When the data capacity is less than the prescribed value (S203: YES), the memory controller 10 selects the SLC blocks as the GC source blocks in the order in which the block numbers are stored in the GC source queue 16 (S204) and executes GC (S205). The memory controller 10 stores the block number of the TLC block generated in the GC at the end of the GC source queue 16 (S206).

On the other hand, when the data capacity exceeds the prescribed value (S203: NO), the memory controller 10 selects the TLC blocks as the GC source blocks in the order in which the block numbers are stored in the GC source queue 16 (S207), and executes GC (S208).

Otherwise, when the lack of the capacity does not occur (S202: NO), the memory controller 10 skips S203 to S208, and ends the processing regarding GC.

As above, the memory system 1 of the second embodiment can also appropriately control arrangement of data and achieves both maintenance of writing performance and securing of the storage capacity for data.

While certain embodiments have been described, these embodiments have been presented by way of example only and are not intended to limit the scope of the disclosure. Indeed, the novel devices and methods described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is

1. A memory system comprising:
a nonvolatile memory having a plurality of blocks each including a plurality of cells; and
a memory controller that is connectable to a host and controls the nonvolatile memory, wherein
the memory controller is configured to:
execute, for each of the plurality of blocks, first writing to write N-bit data (N is an integer not less than 1) into one cell and second writing to write M-bit data (M is an integer greater than N) into one cell;
maintain a first queue for storing block numbers respectively assigned to the plurality of blocks;
in response to a write request from the host, write data to the nonvolatile memory using a first writing and store, in the first queue, block numbers of blocks on which the first writing is executed in an order in which the first writing was executed; and
when executing a garbage collection process to generate an empty capacity in the nonvolatile memory by rewriting and moving the data written with the first writing to be rewritten with the second writing,
acquire the block numbers from the first queue in the order in which they were stored, and
select, as movement source blocks of the garbage collection process, the blocks corresponding to the acquired block numbers are assigned.

2. The memory system of claim 1, wherein
the memory controller is configured to:
execute third writing to write L-bit data (L is an integer greater than N and smaller than M) into one cell;
when a capacity of data stored in the nonvolatile memory is less than a prescribed value in executing the garbage collection process, execute garbage collection process of rewriting and moving the data written in the nonvolatile memory with the first writing into the nonvolatile memory with the third writing; and
when the capacity of the data stored in the nonvolatile memory is not less than the prescribed value in executing the garbage collection process, execute garbage collection process of rewriting and moving the data written in the nonvolatile memory with the third writing into the nonvolatile memory with the second writing.

3. The memory system of claim 2, wherein the memory controller is configured to, when garbage collection process of rewriting and moving the data written in the nonvolatile memory with the first writing into the nonvolatile memory with the third writing is executed, store, in the first queue, block numbers of blocks on which the third writing is executed as movement destination blocks such that an order in which the third writing has been executed is able to be specified separately from the order of the writing regarding the blocks on which the first writing is executed.

4. The memory system of claim 3, wherein
the memory controller is configured to:
when garbage collection process of rewriting and moving the data written in the nonvolatile memory with the third writing into the nonvolatile memory with the second writing is executed,
acquire the block numbers of the blocks on which the third writing is executed, in the order in which the third writing has been executed, the block numbers being stored in the first queue, and
in an order in which the block numbers are acquired, select, as movement source blocks of the garbage collection process, the blocks to which the block numbers are assigned and on which the third writing is executed.

5. The memory system of claim 1, wherein
the first writing is SLC (single level cell) writing, and
the second writing is QLC (quad level cell) writing.

6. The memory system of claim 2, wherein
the third writing is TLC (triple level cell) writing.

7. The memory system of claim 1, wherein
the memory controller includes
a host interface circuit for communication with the host, and
a memory interface circuit for data transmission and reception to/from the nonvolatile memory.

8. The memory system of claim 7, wherein the host interface circuit is compliant with a PCI Express™ (PCIe™) standard.

9. The memory system of claim 7, wherein the host interface circuit is compliant with a UFS (Universal Flash Storage) standard.

10. The memory system of claim 7, wherein the memory interface circuit is compliant with a toggle DDR (Double Data Rate) standard.

11. The memory system of claim 7, wherein the memory interface circuit is compliant with an ONFI (Open NAND Flash Interface) standard.

12. A memory controller for controlling a nonvolatile memory having a plurality of blocks each including a plurality of cells, the memory controller being configured to:
execute, for each of the plurality of blocks, first writing to write N-bit data (N is an integer not less than 1) into one cell and second writing to write M-bit data (M is an integer greater than N) into one cell;
maintain a first queue for storing block numbers respectively assigned to the plurality of blocks;
in response to a write request from a host, write the data to the nonvolatile memory using a first writing and store, in the first queue, block numbers of blocks on which the first writing is executed in an order that the first writing was executed; and
when executing a garbage collection process,
acquire the block numbers from the first queue in the stored order, and
select, as movement source blocks, the blocks corresponding to the acquired block numbers to move data to be rewritten with the second writing.

13. The memory controller of claim 12, further configured to execute a third writing and move data from first-writing blocks to third-writing blocks when stored data capacity is below a prescribed value, and from third-writing blocks to second-writing blocks when the capacity is above the prescribed value.

14. The memory controller of claim 13, wherein block numbers of the third-writing destination blocks are stored at an end of the first queue.

15. The memory controller of claim 14, wherein upon receiving a subsequent write request from the host after data has been written using the third writing, the memory controller is configured to insert block numbers for new first writing operations into the first queue at a position before the block number of the block that was the destination for the third writing.

16. The memory controller of claim 12, wherein the garbage collection process arranges data in the destination blocks written with the second writing in an order corresponding to the host write request.

17. A control method of data arrangement in a memory system including a memory controller and a nonvolatile memory having a plurality of blocks each including a plurality of cells, the control method comprising:
executing, via the memory controller, a first writing to write N-bit data (N is an integer not less than 1) into per cell in response to a host request;
storing, in a first queue, block numbers of blocks on which the first writing is executed in an order of execution; and
executing a garbage collection process by moving data from blocks written with the first writing to be rewritten using second writing of M-bit data per cell (where M is an integer greater than N),
during the garbage collection process, acquiring the block numbers from the first queue in the order they were stored, and
selecting, as movement source blocks of the garbage collection process the acquired block numbers.

18. The method of claim 17, further comprising: when a stored data capacity is below a prescribed value, moving data from the first-writing blocks to be rewritten using a third writing of L-bit data per cell, where N<L<M; and storing the block number of a destination block for the third writing in the first queue.

19. The method of claim 18, further comprising: when the stored data capacity is not below the prescribed value, moving data from blocks written with the third writing to be rewritten using the second writing, wherein the source blocks for this move are selected based on their order in the first queue.

20. A non-transitory computer readable storage device having computer readable instructions that, when executed by circuitry, cause the circuitry to perform the method of claim 17.
